(19) United States
(12) Patent Application Publication
(10) Pub. No.: US 2013/0257158 A1
(43) Pub. Date: Oct. 3, 2013

(54) Method for transmission and storage of wind energy

(71) Applicant: Benton Frederick Baugh, Houston, TX (US)

(72) Inventor: Benton Frederick Baugh, Houston, TX (US)

(21) Appl. No.: 13/506,187

(22) Filed: Apr. 3, 2012

(51) Int. Cl. F03D 11/02; H02J 9/08

(52) U.S. Cl. 307/64; 290/55

(57) ABSTRACT

A method of transportation and storage of wind energy, comprising receiving wind energy from a wind turbine in the form of compressed gas, storing of at least a portion of the compressed gas in a pipe, venting a portion of the compressed gas to drive a motor to drive a generator to generate electrical power, and distributing the electrical power to one or more users.

### TECHNICAL FIELD

This invention relates to a method of harvesting wind energy at locations and times where there is ample wind energy available, transporting it to locations where there is a high energy demand, and storing it in the form of compressed gas until the time the demand is present.

### CROSS-REFERENCE TO RELATED APPLICATIONS

Not applicable.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

The field of this invention is that of transportation and storage of wind energy.

Wind energy is important to the development of our economy as it represents a clean, zero pollution method of generating the electricity we need while reducing our dependence on foreign oil. Wind energy is typically generated by a wind turbine which is a multiplicity of blades around a central shaft which drives an electric generator.

The primary historic use of wind energy has been to drive a water pump or to grind grain. Today the generation of electricity is the primary focus of modern wind energy research and development. When the electricity is generated locally at the wind turbine, it must then be transported by wires to the location where the electricity is needed. Typically, the abundant winds, i.e. in west Texas, and the major users of electricity, i.e. Dallas, Tex., are in different locations. Major electrical wires must be strung for the delivery of the electricity. Much of the electricity is simply lost in the resistance of the electric wires.

A more substantial problem is that the peak demand for the electricity, i.e. the hottest part of the day, is frequently not when the peak winds are blowing. The electricity must be used when it is generated as it cannot be stored. It can be used by simply turning off the fossil fuel generators to use the wind power electricity. However, it cannot be depended upon for peak power as it simply may not be available during periods of peak power needs. The fossil fuel powered generators must be built large enough to carry the entire load. This eliminates one of the major savings of wind energy—the reduction in capital costs of alternate methods of generations such as the fossil fuel generator systems.

The “holy grail” of wind energy has been how to store the energy until it is actually needed. Massive amounts of research have been applied to this with minimal success to date. If one can depend on generating the electricity from wind power when the wind is greatest and using it when the demand is greatest, it means both that the wind energy can fully be used and the capital costs of alternative methods can be reduced.

### BRIEF SUMMARY OF THE INVENTION

The object of this invention is to a system for harvesting wind energy when and where the wind energy is abundantly present.

A second object of this invention is to store the wind energy until it is needed.

A third object of this invention is to deliver the wind energy to a location remote to the harvesting location.

Another object of the present invention is to provide a method of transportation of wind energy which minimizes delivery losses.

### BRIEF DESCRIPTION OF THE DRAWINGS

FIG. 1 is a view of a the system of this method including a location for the harvesting of wind energy, the transportation/storage pipeline, and the end users of the energy.

### DETAILED DESCRIPTION OF THE INVENTION

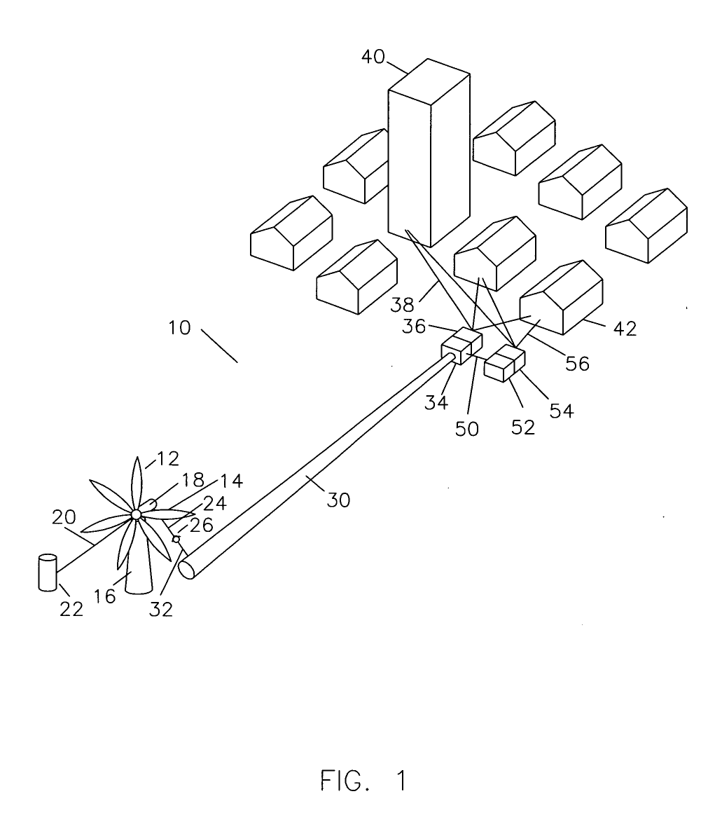

Referring now to FIG. 1, a wind energy system 10 comprises a wind generator 12 having a multiplicity of blades 14 and being mounted on a stand 16. The multiplicity of blades 14 drive a gas pump 18. The gas pump 18 is for the purpose of compressing gas and may be of any number of types including being a vane pump, gear pump, piston pump, all of which are well known in the art. The gas pump can be of a fixed displacement or variable displacement, which are well known in the art. It is particularly advantageous to be of variable displacement type as both the speed of the wind and the pressure in the vessel the compressed gas will be delivered to are variable. In some cases a high volume of low pressure gas is appropriate and in other cases a low volume of high pressure gas is appropriate, but they can require similar power to compress.

The inlet 20 to the gas pump 18 can be attached to a gas well 22 or simply be open to the environment such that air is pumped.

The outlet line 24 from gas pump 18 goes through a check valve 21 and connects to pipeline 30 at inlet 32.

A distanced down pipeline 30 is a first motor 34 which receives the compressed gas output from gas pump 18 and drives a generator 36. The first motor can be of any of a number of types such as vane, gear, or piston and can be of fixed or variable displacement. It is particularly advantageous to be of variable displacement as the gas coming to the motor from the pipeline will be of a variable pressure. Electrical lines 38 deliver the resultant electricity to users indicated as building 40 and homes 42.

If the gas compressed by gas pump 18 was a burnable gas such as from well 22, the lower pressure discharged gas from first motor 34 can be delivered along line 50 to a second motor 52 which drives generator 54. The second motor can be an internal combustion motor such as a diesel cycle engine, a gasoline cycle engine, or a turbine. It could also be an external combustion engine such as a Sterling cycle engine or a steam engine. Electrical lines 56 deliver the resultant electricity to users indicated as building 40 and homes 42

This combination is particularly convenient in areas of West Texas where there are gas wells whose pressure is largely depleted and pipelines exist but are only minimally used. Compressing this natural gas for delivery at a great distance not only improves the transportability of the gas, but delivers the wind energy as it delivers the gas. At the receiving end, first the wind energy is removed from the compressed gas by a first type motor and then the chemical energy of the gas is removed by burning. In both cases the energy is converted to electricity for delivery to users.

As an example of the benefit of this method, consider a 10¾″ outside diameter×10.020″ internal diameter pipeline from Big Lake in West Texas to Dallas, Tex. The distance is approximately 327 miles according to Google Maps, and a pipeline is never as straight across country as a road. The horsepower required to compress 1 SCFM of air from 0 p.s.i.g. to 1500 p.s.i.g. in 1 minute is 0.0386 (Womack Machine Supply Co. catalog.) In 327 miles of this pipeline at 1500 p.s.i.g. there are 97,421,500 SCFM. Horsepower required to compress this gas over a 24 hour period would be a steady 79.86 hp per mile or a total of 26,144 hp for the entire pipeline. That horsepower relates to an electrical energy of 1429 KWH or kilowatt hours.

The average US home uses 8900 KWH per year according to “Electrical Energy.” The New Book of Popular Science. 2000 edition. Grolier Incorporated, 1998. This relates to an average of 24.367 KWH per day. With 26,144 KWH available, it says the pipeline would service 19,188 households. Similar calculations using a 30″ outer diameter by 0.500″ wall thickness pipe yields that it would service 16,728 households. Either of these pipelines would make a significant contribution to the energy supply in Dallas, Tex.—especially as the time of compression of the gas is functionally independent of the time of usage of the compressed gas.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

SEQUENCE LISTING: N/A

That which is claimed is:

1. A method of transportation and storage of wind energy, comprising:
receiving wind energy from a wind turbine in the form of compressed gas,
storing of at least a portion of said compressed gas in a pipe,
venting a portion of said compressed gas to drive a motor to drive a generator to generate electrical power, and
distributing said electrical power to one or more users.

2. The method of claim 1 further comprising said receiving of wind energy and said venting of a portion of said compressed gas occurs at locations along said pipe at least one mile apart.

3. The method of claim 1 further comprising compressing said compressed gas in a variable displacement compressor.

4. The method of claim 1 further said motor is a variable displacement motor.

5. The method of claim 1 further comprising said receiving of wind energy and said venting of a portion of said compressed gas occurs at locations along said pipe at least one mile apart, compressing said compressed gas in a variable displacement compressor, and said motor is a variable displacement motor.

6. A method of harvesting, transportation, storage, and distribution of wind energy, comprising:
providing one or more blades for harvesting energy from the wind mounted about a shaft for converting said wind energy into rotary power,
providing a gas compressor (pump) for converting said rotary power into energy stored as compressed gas,
storing of at least a portion of said compressed gas in a pipe,
venting a portion of said compressed gas to drive a first motor to drive a generator to generate a first electrical power,
distributing said first electrical power to one or more users,
venting the exhaust of said compressed gas from said first motor to a second motor for burning to produce a second electrical power, and
distributing said second electrical power to one or more users.

7. The method of claim 6 further comprising said gas compressor is a variable volume compressor.

8. The method of claim 6 further comprising said first motor is a variable displacement motor.

9. The method of claim 6 further comprising said gas compressor is a vane type compressor.

10. The method of claim 6 further comprising said gas compressor is a piston type compressor.

11. The method of claim 6 further comprising said first motor is a vane type motor.

12. The method of claim 6 further comprising said first motor is a piston type motor.

13. The method of claim 6 further comprising said second motor is an internal combustion engine.

14. The method of claim 13 further comprising said second motor is a diesel cycle engine.

15. The method of claim 13 further comprising said second motor is a turbine.

16. The method of claim 6 further comprising said second motor is an external combustion engine.

17. The method of claim 16 further comprising said second motor is a steam engine.

18. The method of claim 16 further comprising said second motor is a sterling cycle engine.
